(19) United States
(12) Patent Application Publication
(10) Pub. No.: US 2006/0001667 A1
(43) Pub. Date: Jan. 5, 2006

(54) Mathematical sketching

(75) Inventors: Joseph LaViola JR., Providence, RI (US); Robert C. Zeleznik, Barrington, RI (US)

Correspondence Address: Lawrence M. Green;Wolf, Greenfield & Sacks, P.C., 600 Atlantic Avenue, Boston, MA, 02210, US

(73) Assignee: Brown University, Providence, RI (US)

(21) Appl. No.: 11/170,381

(22) Filed: Jun. 29, 2005

Related U.S. Application Data
(60) Provisional application No. 60/585,297, filed on Jul. 2, 2004.
(60) Provisional application No. 60/585,298, filed on Jul. 2, 2004.

(51) Int. Cl. G06T 13/00; G06T 15/70

(52) U.S. Cl. 345/473

(57) ABSTRACT

A mathematical sketching system enables a user to intuitively investigate the relationship between mathematical expressions and diagrams in a user-friendly manner. In one embodiment, a mathematical sketching system enables a user to input handwritten mathematical expressions and hand-drawn drawing elements, form associations between the mathematical expressions and the drawing elements, and view an animation of the drawing elements as their movements are displayed based on the mathematical expressions.

### RELATED APPLICATIONS

This application claims priority under 35 U.S.C. § 119(e) to U.S. Provisional Application Ser. No. 60/585,298, entitled “Mathematical Sketching,” filed on Jul. 2, 2004, and U.S. Provisional Application Ser. No. 60/585,297, entitled “Electronic Ink System,” filed on Jul. 2, 2004, both of which are herein incorporated by reference in their entireties.

### RELATED ART

1. Field of Invention

The invention relates generally to displays of mathematical relationships. More specifically, the invention relates to animating the computerized display of gesturally-input drawings based on mathematical expressions.

2. Discussion of Related Art

Diagrams and illustrations are often used in publications to help explain mathematical concepts. They are commonplace in mathematics and physics textbooks and provide a form of physical intuition about abstract principles. Similarly, pencil-and-paper diagrams are often drawn by individuals when solving mathematics problems, to help in visualizing relationships among variables, constants and functions. Using diagrams as a guide, appropriate mathematical expressions for solving a problem can be developed. However, such diagrams typically are static in that they are not animated. As such, static diagrams generally assist only in the initial formulation of mathematical expressions, and not in the “debugging” or analysis of those expressions. This lack of animation can be a limitation in explaining and solving mathematical problems, even for simple problems with natural mappings to the temporal dimension, let alone problems with complex spatial relationships.

Software applications are available today that enable a user to create animated diagrams of mathematical concepts. Such applications typically are WIMP-based (i.e., Windows, Icons, Menus, Pointers) and/or limit the user to specific drawing primitives or specific disciplines (e.g., physics, mechanics, etc.).

Some software applications enable a user to sketch a diagram that the application then animates, for example, as described in Alvarado, C. J., 2000, A Natural Sketching Environment: Bringing the Computer into Early Stages of Mechanical Design, Master's Thesis, Massachusetts Institute of Technology (hereinafter, “Alvarado”) and Kara, L. B., Gennari, L., and Strahovich, T. F., 2004, A sketch-based interface for the design and analysis of simple vibratory mechanical systems, In Proceedings of ASME International Design Engineering Technical Conferences (hereinafter, “Kara”). With these applications, the user sketches a diagram that the application recognizes as a drawing primitive based on previously defined domain knowledge (i.e., specific disciplines). The program then animates the diagram based on this recognition.

### SUMMARY OF INVENTION

According to one embodiment of the invention, a system comprises a user interface module to receive a gestural drawing element and a gestural mathematical expression from a user. The system further comprises an animation module to control a display of the gestural drawing element based on the gestural mathematical expression.

According to another embodiment of the invention, a system comprises a user interface module to receive a drawing element and a gestural mathematical expression from a user. The system further comprises an association module to associate the gestural mathematical expression to the drawing element.

According to another embodiment of the invention, a system comprises a user interface module to receive a gestural drawing element and a mathematical expression from a user. The system further comprises an association module to associate the mathematical expression to the gestural drawing element.

According to a further embodiment of the invention, a computer-readable medium has instructions stored thereon that, as a result of being executed by a computer, instruct the computer to perform a method comprising acts of receiving a gestural drawing element and a gestural mathematical expression from a user, and animating a display of the gestural drawing element based on the gestural mathematical expression.

According to another embodiment of the invention, a computer-readable medium has instructions stored thereon that, as a result of being executed by a computer, instruct the computer to perform a method comprising acts of receiving a drawing element and a gestural mathematical expression from a user, and associating the gestural mathematical expression to the drawing element.

According to yet another embodiment of the invention, a computer-readable medium has instructions stored thereon that, as a result of being executed by a computer, instruct the computer to perform a method comprising acts of receiving a mathematical expression and a gestural drawing element from a user, and associating the mathematical expression to the gestural drawing element.

According to another embodiment of the invention, a computer-implemented method of animating a display of at least one drawing element based on at least one gestural mathematical expression comprises inputting at least one gestural drawing element and at least one gestural mathematical expression into a system, associating at least one of the gestural mathematical expressions to at least one of the gestural drawing elements, and instructing the system to animate a display of the at least one gestural drawing element based on the gestural mathematical expression.

According to yet another embodiment of the invention, a computer-implemented method of animating a display of one or more drawing elements based on one or more handwritten mathematical equations comprises drawing one or more drawing elements on a digitized surface, handwriting one or more mathematical equations on the digitized surface, associating at least one of the handwritten mathematical equations to at least one drawing element using a gesture command, and initiating animation of the at least one drawing element by tapping a virtual button on the digitized surface.

In another embodiment of the invention, a computer-implemented method of animating a display of one or more drawing elements based on at least one gestural mathematical equation comprises inputting one or more drawing elements, inputting one or more gestural mathematical equations, and associating at least one of the gestural mathematical equations to at least one of the drawing elements. The method further comprises animating the at least one drawing element, comparing the animation of the at least one drawing element to an expected animation, and revising at least one of the gestural mathematical equations based on the comparison.

### BRIEF DESCRIPTION OF DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For the purposes of clarity, not every component is labeled in every figure, nor is every component of each embodiment of the invention shown where illustration is not necessary to allow those of ordinary skill in the art to understand the invention.

In the figures:

FIG. 1 illustrates a mathematical sketching system according to one embodiment of the invention;

FIG. 2 illustrates an example of a display screen displaying a set of handwritten mathematical expressions and hand-drawn drawing elements that have been gesturally input into a mathematical sketching system, according to one embodiment of the invention;

FIG. 3 is a block diagram illustrating an example of a system for animating a gesturally input drawing based on a gesturally input mathematical expression according to one embodiment of the invention;

FIG. 4a is a block diagram of one embodiment of the sketch parser module that may be included in the system shown in FIG. 3;

FIG. 4b is a block diagram of a one embodiment of the mathematical recognition module that may be included in the sketch parser module shown in FIG. 4a;

FIG. 5 is a flowchart illustrating an example of a method of initiating animation of a hand-drawn drawing based on a handwritten mathematical expression according to one embodiment of the invention;

FIG. 6 is a table illustrating examples of gestures that may be used for inputting mathematical expressions, drawing elements, and/or commands according to one embodiment of the invention;

FIG. 7 illustrates an example of a display screen displaying a user-drawn diagram and a set of handwritten mathematical expressions from which the drawing may be animated according to one embodiment of the invention; and

FIG. 8 shows a block diagram of one embodiment of a general purpose computer system.

### DETAILED DESCRIPTION

This invention is not limited in its application to the details of construction and the arrangement of components set forth in the following description or illustrated in the drawings. The invention is capable of other embodiments and of being practiced or of being carried out in various ways.

Definitions

As used herein, the terms “mark” and “ink mark” mean any complete or partial symbol, sign, number, dot, line, curve, character, text, drawing, image, picture, or stroke that is made, recorded, and/or displayed.

As used herein, the term “gestural input” means an input that is provided to a system by a user through the use of handwriting, a hand movement, or a body movement, including, for example, the use of a stylus on a digitizing surface or other touch-sensitive screen, a finger on a touch-sensitive screen, a light pen, a track ball, and a computer mouse, among others. Gestural inputs are not intended to mean selections of drawing primitives or alphanumeric codes from menus, or the use of keyboards, selection pads, etc., although such inputs may be used in combination with gestural inputs in some embodiments.

As used herein, the term “gesture mark” means any complete or partial symbol, sign, number, dot, line, curve, character, text, drawing, or stroke that is recorded from human movement. A display of the mark corresponding to the movements of the human in making the gesture may be shown during and or after the movement. For example, gesture marks may be made with the use of a stylus on a digitizing surface. In another example, a computer mouse may be used to form gesture marks.

As used herein, the term “gesture command primitive” means an individual gesture mark that, either alone or in combination with other gesture command primitives, specifies performance of, defines, or indicates a portion of or all of a gesture command.

As used herein, the terms “stroke” and “ink stroke” mean a mark that includes a line and/or a curve. An ink stroke may be a line of darkened pixels formed or displayed on a digitizing surface. Another example of an ink stroke is a curve formed on a piece of paper with a regular ink pen.

As used herein, the term “gesture command” means a gestural input that instructs a system to perform a function other than only displaying the gesture mark or marks that are made with the gestural input. In other words, many gesture marks are displayed such that the resulting marks correspond to the gesture movements used to make the marks, while some gesture marks are recognized to be a gesture command primitive and/or a gesture command that instructs the system to perform a function.

As used herein, the term “gestural drawing element” means a gesture mark or gesture command that results in the display of the gesture mark or any other mark.

As used herein, the term “gestural mathematical expression” means a set of gesture marks that form a mathematical expression or gesture commands that form a mathematical expression. A mathematical expression need not be an entire equation. A partial equation or even a single digit is considered to be a mathematical expression for purposes herein.

As used herein, the term “electronic ink” means the digital information representing handwriting or other strokes recognized, recorded or displayed by/on a computer.

As used herein, the term “mode” means a state of a system in which the system is configured to receive a certain type of input and/or provide a certain type of output. As used herein, the term “input surface” means a surface that receives or accepts input from a user.

As used herein, the term “computational engine” means any system (e.g., module, apparatus, device, processor, program, other systems, or any combination thereof) that performs mathematical functions, or follows program instructions, or operates on logical expressions or iterative operators. For example, a typical computer processor, a calculator, and a computational program such as Matlab™, individually or in any suitable combination are all examples of a computational engine.

As used herein, the term “association” means an operative connection of at least two entities, regardless of whether the entities are explicitly shown to be connected. For example, two entities may be associated via a memory connection in a processor.

As used herein, the term “lasso” means an ink stroke or mark, or a set of ink strokes or marks, that partially or completely encloses one or more ink marks.

Overview

There remains a need for tools that allow a user to intuitively investigate the relationship between mathematical expressions and diagrams in a user-friendly manner. Accordingly, described herein are systems and methods for enabling a user to animate a diagram (e.g., a gesturally-input diagram) based on gesturally-input mathematical expressions (or mathematical expressions input in some other fashion). One or more gesturally input mathematical expressions may be associated with a diagram so that the diagram can be animated based on the mathematical expression. The association may include relationships between elements of the drawings and elements of the mathematical expression. This association and the relationship thereof may be maintained throughout the animation and may be recorded (e.g., in a database).

Animating a diagram (e.g., a gesturally-input diagram) based on a gesturally-input mathematical expression enables users to evaluate different formulations based on their physical intuitions about motion. Users can discern mismatches between animated and expected behaviors, often realizing that a mathematical expression is incorrect and making better educated guesses as to the reasons. Further, correct formulations can be explored intuitively, perhaps to focus on an aspect of the problem to study with a conventional numerical or graphing technique.

According to one embodiment of the invention, a system, e.g., a mathematical sketching system, enables a user to input handwritten mathematical expressions and hand-drawn drawing elements, form associations between the mathematical expressions and the drawing elements, and view an animation of the drawing elements as their movements are displayed based on the mathematical expressions.

The system may enable a user to input mathematical expressions by writing the mathematical expressions on an input surface, for example, on a digitizing surface, and to instruct the system, with a simple gesture command formed with one or more gesture command primitives, to attempt to recognize the expression and convert it into a format that facilitates manipulation of the expression by the system. Similarly, the system may enable a user to input drawing elements by hand-drawing various elements and grouping the elements together with a simple gesture command.

Associations may be made between the mathematical expressions and the drawing elements implicitly, explicitly, or as a combination thereof. Regardless of how the associations are made, various drawing elements may be mathematically connected to the mathematical expressions such that movement of the drawing elements is displayed based on the mathematical expressions. In this manner, drawing elements may be animated to show a visual representation of the mathematical expressions. In some embodiments, other displays such as charts or graphs, may be produced.

According to another embodiment of the invention, drawing elements are gesturally input while mathematical expressions are input in any suitable manner.

Associations are made between the mathematical expressions and the drawing elements, implicitly, explicitly, or as a combination thereof. An output display of the drawing elements is based on the mathematical expressions associated with the drawing elements. In some embodiments, symbolic manipulation or other mathematical actions may be initiated in response to gestural commands. For example, a user may be enabled to initiate the simplification or factoring of an expression, or the solving of an equation, by using simple written gesture strokes to provide commands.

Systems such as those described above may provide a user with a method of viewing a visualization or animation of mathematical expressions without learning a complex programming language. In some embodiments, a simple gesture or sequence of gestures is sufficient to instruct the system to perform various tasks, as described below with reference to the figures, and in a provisional patent application No. 60/585,298 entitled, “Electronic Ink System”, filed on Jul. 2, 2004. For example, a temporal sequence of three gesture marks may be used to input a command into the system without using a command menu or being required to select a “command mode” before inputting the command. An exemplary sequence includes a context gesture mark to define a context for a command (e.g., an area of a drawing), an action gesture mark to indicate a command action, and a terminal gesture mark to initiate performance of the command on the defined context.

According to some embodiments, the mathematical sketching system is flexible in that mathematical expressions and drawing elements are not restricted to certain domains (e.g., physics, mechanics, etc.) or drawing primitives. That is, any combination of marks may be input as a drawing element or diagram, and any mathematical expression that uses recognizable mathematical, logical, iteration or programming operators may be input. In some embodiments, however, it is possible to pre-define certain drawing elements, for example, by assigning a square to represent a mass, or assigning a circle with a perpendicular line extending away from the circle to represent a pendulum. In other embodiments, there is no correlation of certain shapes or drawing elements to specific entities or mathematical expressions. This flexibility can give the user more freedom to explore the relationships of mathematical expressions and displayed representations.

Various embodiments of the invention allow a user to harness the power of a computational and/or animation engine while using the familiar gestural strokes used in pencil-and-paper-style interaction. In certain embodiments, operation of the system is “modeless”; that is, the user can write and draw with a stylus or other implement, and there is no requirement to distinguish text from drawing elements, for example, by using drop down menus or input devices (such as a button on the stylus or on a touch-sensitive screen). Of course, in other embodiments, modes may be used to distinguish textual input from drawing input.

Mathematical Sketching System

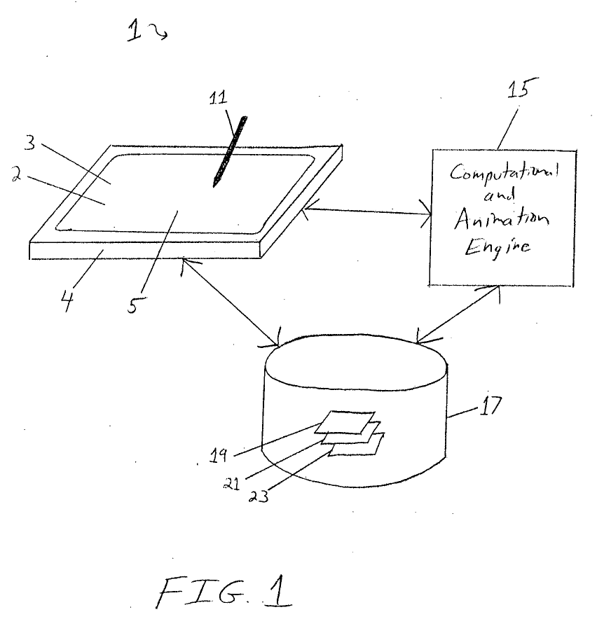

FIG. 1 illustrates a mathematical sketching system 1 according to one embodiment of the invention. An input/output device 2 including a display screen 3 and a digitizing surface 5 associated with a tablet computer 4 may be operatively connected with a computational and animation engine 15 and a database 17. Digitizing surface 5 may be configured to receive input from stylus 11 in the form of handwritten mathematical expressions, hand-drawn drawing elements, and, optionally, handwritten links between drawing elements and mathematical expressions. Information representing these inputs may be stored in database 17, for example, in one or more data structures. For example, database 17 may include drawing element data structures 19, mathematical expression data structures 21, and linking data structures 23.

In this embodiment, computational and animation engine 15 may animate a display of stored drawing elements on display screen 3 which underlies digitizing surface 5 on input/output device 2. The content of the animation may be controlled by associations between the drawing elements and the mathematical expressions. Computational and animation engine 15 may create these associations by associating one or more of the mathematical expressions to one or more of the drawing elements, in part by using linking data structures 23. Linking data structures 23 may be created and stored based on user input or algorithms performed by computational and animation engine 15.

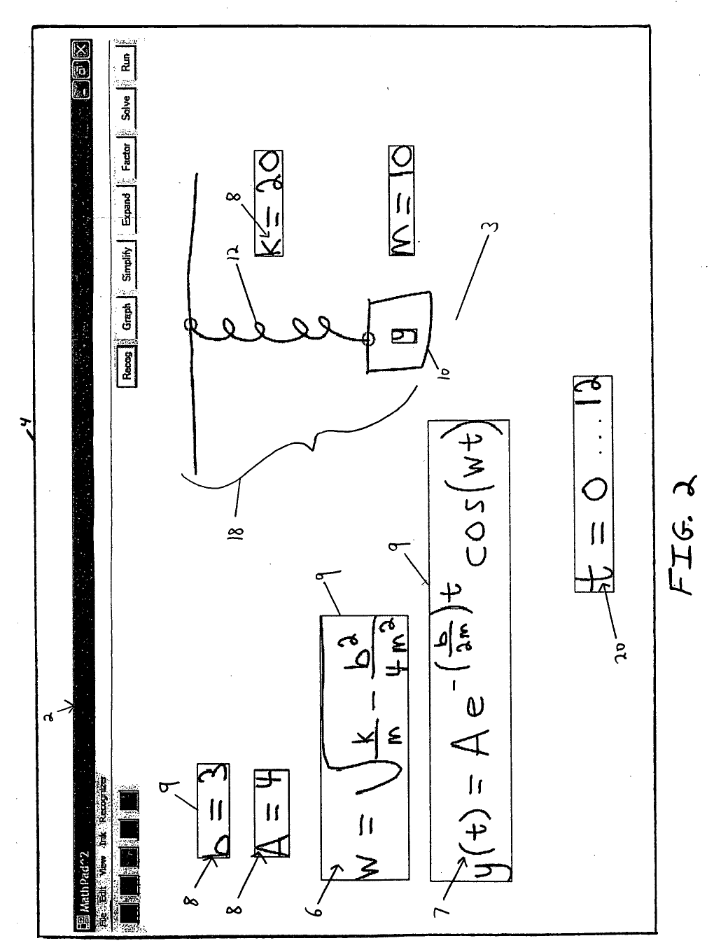

FIG. 2 illustrates an example of display screen 3 (e.g., as part of a tablet computer 4) displaying a set of handwritten mathematical expressions and hand-drawn drawing elements that were input into a mathematical sketching system using free-form hand movements, according to one embodiment of the invention. Display screen 3 includes mathematical equations 6, 7, values assigned to constants 8, bounding boxes 9, and a range of values assigned to domain variable 20, and a diagram 18 which includes drawing elements 10, 12, 14. Mathematical equations 6, 7 and values assigned to constants 8 are shown in bounding boxes 9 to indicate that the expressions have been recognized by the system. In some embodiments, the recognized expressions are displayed in the user's own handwriting. In other embodiments, the recognized expressions may be displayed in a type set or in a handwritten font other than the user's.

Diagram 18 includes three drawing elements: a mass 10; a spring 12; and a ceiling 14. It is important to note that in some embodiments, these drawing elements are not recognized or assigned by default to certain elements or drawing primitives, rather they are simply displayed as they are input by the user, and the system recognizes them as no more than marks or ink strokes. In some embodiments, however, the system may recognize certain marks or sets of marks as a predefined drawing element and display the drawing element by using a previously stored drawing element. In some embodiments, clipart or other previously stored drawing elements may be directly selected and added to a diagram.

The movements displayed in an animation of the drawing elements (e.g., spring 12 and mass 10 in this example) may be controlled by the mathematical expressions that are associated with the drawing elements, as is described in more detail below. Diagram 18 represents the initial condition of an animation. The initial condition may be defined to be the value of the expressions when domain variable 20 is at its initial value. In this example, domain variable 20 is variable t and is defined to progress from 0 to 12. In some embodiments, there may be a default domain for a mathematical sketch, and in some embodiments, the user may also control the speed, duration and/or display frequency of an animation. In some embodiments, an animation may be created by producing a drawing that is in a state other than an initial condition.

After mathematical expressions 6, 7, 8 and mass 10 have been associated, and domain variable 20 has been defined, the user may initiate an animation of diagram 18. Upon initiation, the system animates diagram 18. In this example, mass 10 oscillates up and down with a decreasing amplitude as the animation progresses. As illustrated in FIG. 2, one end of spring 12 is pinned to ceiling 14 and the other end is pinned to mass 10. As such, spring 12 stretches so that the end pinned to mass 10 moves with mass 10, and the end attached to ceiling 14 does not move. Changes to constants 8 and/or mathematical equations 6, 7 may affect the animation and enable the user to see the change in the movement of mass 10 due to the revisions.

In addition to allowing the exploration of the effects of various constant and mathematical expression changes, the system may enable a user to test the correctness of a mathematical equation. For example, if a sign or mathematical operator were incorrectly entered into either or both of mathematical equations 6, 7, an animation of diagram 18 might reveal the mistake and may be helpful in determining the source of the error. In this manner, the mathematical sketching system may help a user to “debug”, or revise, an equation or a set of equations by allowing comparison of the animation to an expected animation.

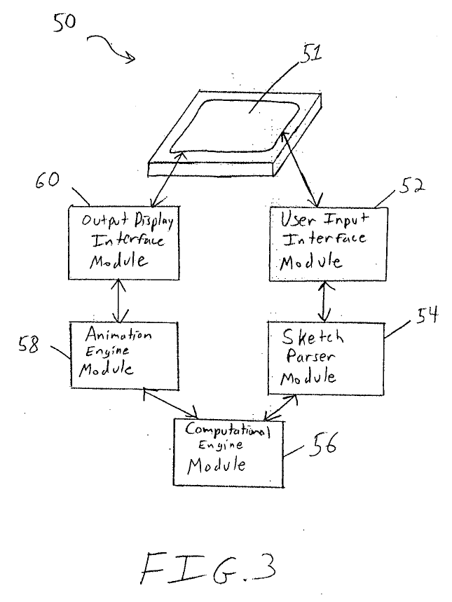

Various embodiments of the invention may be implemented using a system, of which a block diagram of one embodiment is illustrated in FIG. 3. In this embodiment, a system 50 may include any of a input/output device 51, a user input interface module 52, a sketch parser module 54, a computational engine module 56, an animation engine module 58, and an output display interface module 60. Functions and/or structures of the modules are described below, but it should be appreciated that the functions and structures may be dispersed across two or more modules, and each module does not necessarily have to perform every function described.

User input interface module 52 may receive inputs from any of a variety of types of user input devices, for example, a keyboard, a mouse, a trackball, a touch screen, a pen, a stylus, a light pen, a digital ink collecting pen, a digitized surface, a microphone, other types of user input devices, or any combination thereof. The form of the input in each instance may vary depending on the type of input device from which the interface module 52 receives the input. In some embodiments, inputs may be received in the form of ink strokes (e.g., from a digitized surface), while in other embodiments some pre-processing of a user's handwriting or other gestural inputs may occur. User input interface module 52 may receive inputs from more than one source. For example, drawing elements may be received from a digitized surface (e.g., of a tablet computer) while text may be received from a keyboard. In some embodiments, both text and drawing elements are received from a single input/output device 51.

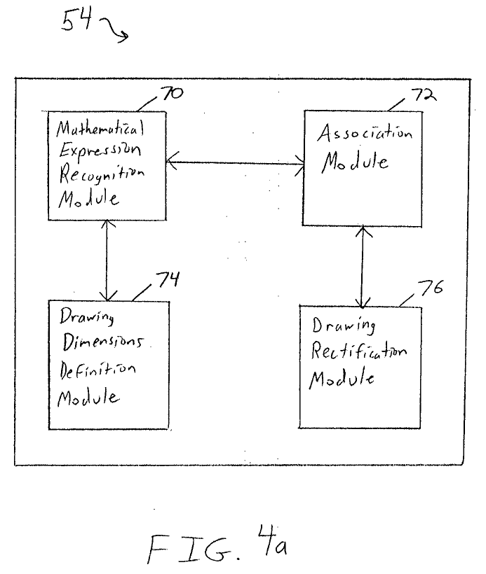

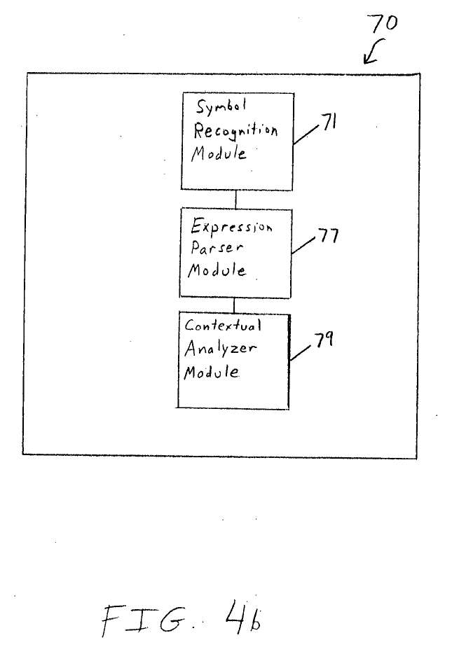

Information received at the user input interface module may be passed to sketch parser module 54 so that the information can be converted into a format that facilitates manipulation by the system. In some embodiments, sketch parser module 54 receives information with data that indicates whether the information represents a drawing element or text (such as, for example, a mathematical equation). In other embodiments, sketch parser module 54 receives information with no indication as to the content of the information and may determine the type of content provided. The data that indicates whether the information represents a drawing element or text may come from a gesture command provided by the user. A description of one embodiment of sketch parser module 54 is provided below with reference to FIG. 4a.

While in some embodiments a sketch parser module may be used which converts information (such as gesture marks, drawing elements, or mathematical expressions) into an intermediate format that facilitates manipulation by the system before passing data to a computational engine module, in other embodiments, a system may not explicitly convert such information into an intermediate format. Instead, in some embodiments, a system may operate directly on the gesture marks as input by the user.

Once mathematical expressions are parsed (e.g., into strings) and converted to a format that facilitates manipulation by the system, the data may be passed to a computational engine module 56. Various commercially available computational engines may be used to operate on the data. For example, MatLab™, available from The Mathworks of Natick, Massachusetts, may be used to calculate the values of mathematical equations. The type or form of computational engine module 56 is not intended to be limiting, as any suitable program, system, module or apparatus may be used to meet the mathematical processing requirements of various embodiments of the invention. Animation engine module 58 animates the drawing elements provided by the user. In one embodiment, animation engine module 58 first checks each drawing element with its respective association to determine whether it is animatable, that is, whether it is associated with a function of a domain variable. In some embodiments an animatable drawing element may be associated with a function of a time. Drawing elements deemed to be animatable may have their associated mathematical expressions sent to computational engine module 56, which performs the mathematical operations and returns the results to animation engine module 58.

In some embodiments, animation engine module 58 has a default setting such that all animations last for a specific array of values for a domain variable. For example, animation engine module 58 may include a default setting that an animation lasts for four seconds. The default may be overridden in some embodiments by specifying the array of value for a domain variable of an animation. In some embodiments, a domain could be infinite. For example, in one embodiment, an animation may continue to run indefinitely until a user stops the animation. In some embodiments, an animation may not have an explicit starting point. For example, an animation may continuously be running as drawing elements and mathematical expressions are added to the system. For purposes herein, the term “animating” does not require that the resultant animation have a defined starting and/or ending point.

Output display interface module 60 provides information and/or instructions to input/output device 51. As mentioned above, input/output display device may have an output display that partially or entirely overlaps with an input surface. For example, a display screen overlaid with a digitizing surface (e.g., as part of a tablet computer) may be used as input/output device 51. Other output displays are contemplated, such as three-dimensional displays, or any other suitable display devices which are useful for displaying mathematical expressions, animations or simulations. The system may be configured to provide audio output as well, for example, in conjunction with the display.

One embodiment of a sketch parser module 54 is illustrated in FIG. 4a. In this embodiment, four modules are described: a mathematical expression recognition module 70; an association module 72; a drawing dimensions definition module 74; and a drawing rectification module 76. While the four modules are shown as separate modules, the functions and/or structures of each of the modules may overlap with others of the four modules, and in some cases, additional modules or fewer modules may be used.

Mathematical expression recognition module 70 converts user inputs of mathematical expressions into a format that facilitates manipulation by the system. In an embodiment that includes the acceptance of handwritten inputs, one of a writer-dependent system, a writer-independent system, or a hybrid of the two, may be used. In one embodiment, module 70 comprises a writer-dependent system which uses samples of a particular user's handwriting (e.g., stored in database 17 shown in FIG. 1) both to recognize terms in mathematical expressions as well as present recognition results as feedback to the user. In other embodiments, module 70 may use examples of a particular user's handwriting for only one of the above functions.

As described above, by presenting recognition results to the user in the user's own handwriting in some embodiments, a pencil-and-paper look and feel can be maintained.

In one embodiment, a multi-stage mathematical expression recognition module 70 is implemented. A symbol recognition module 71 may be included within mathematical recognition module 70 according to some embodiments, for example, in the embodiment shown in FIG. 4b. In one embodiment, symbol recognition module 71 performs three stages. In a first stage, a pre-processing step is performed. In a second stage, a course classification is performed, and in a third stage, a fine classification step is implemented.

According to this embodiment, in the first stage, a pre-processing step is performed wherein ink strokes are normalized and filtered to reduce noise. The ink strokes also may be made size- and translation-invariant in this step. In addition, dominant points and their directions as well as other statistical features may be calculated for use in later classification steps.

In the second stage, coarse classification may be used to decrease the number of possible mathematical symbol candidates by rejecting unlikely candidates. The second stage is intended to be fast and not fully exhaustive. The coarse classification stage may use two separate algorithms. The first algorithm may use the direction information as input to a dynamic programming algorithm that calculates the optimal degree of difference or similarity between two characters. See Li, X., and Yeung, D.-Y. 1997. On-line handwriting alphanumeric character recognition using dominant points in strokes. Pattern Recognition 30, 1, 31-44, which is hereby incorporated by reference herein in its entirety. The second algorithm performs a statistical features-set classification based on the work of Smithies, S., Novins, K., and Arvo, J. 1999, “A Handwriting-Based Equation Editor,” In Proceedings of Graphics Interface '99, 84-91, which is hereby incorporated by reference herein in its entirety. The results of the two algorithms then may be merged using an averaging scheme normalized by their respective standard deviations.

In the third stage, a fine classification step takes the list of mathematical symbol candidates from the coarse classification stage and uses dynamic programming to determine the best possible match with samples of handwritten mathematical symbols that were previously entered by the user. The fine classification stage may use a dynamic program that is similar to the program used in the coarse classification stage, but also may use dominant points as input, which helps to detect small differences between similar mathematical symbols.

The above-described embodiment of symbol recognition module 71 is provided as an example and is not intended to be limiting. Any suitable recognition algorithm, method or module may be used instead of, or in combination with, the above-described module.

In another embodiment of symbol recognition module 71, a pairwise approach is used in which symbol recognition module 71 compares pairs of candidate symbols and selects which symbol of the pair better matches the target symbol, that is, the handwritten or otherwise gesturally-input symbol that is the target of symbol recognition module 71. This comparison is performed for each unique pair of candidate symbols found in a defined set of candidate symbols. The target symbol is determined to be the candidate symbol that is selected most often during the comparisons of every unique pair.

In a first step of this embodiment of the method, the number of candidate symbols is reduced by sending the target symbol to a handwriting analyzer such as the Microsoft Handwriting Analyzer which delivers a list of candidate symbols. Symbols that the Microsoft Handwriting Analyzer does not have in its database may be added to this list of candidate symbols.

The pairwise approach uses a classifier system to select which symbol of each unique pair of symbols from the list of candidate symbols better matches the target symbol. In some embodiments, an AdaBoost classifier system may be used. The AdaBoost classifier system is discussed in Schapire, Robert E., “The boosting approach to machine learning: An overview,” In MSRI Workshop on Nonlinear Estimation and Classification, 2002, which is hereby incorporated by reference herein in its entirety. For each unique pair of candidate symbols, a set of weighted weak classifiers, i.e., an AdaBoost classifier, selects one candidate symbol or the other as most closely matching the target symbol. A weak classifier operates on a single feature of symbols. For example, a first weak classifier may examine stroke length, a second weak classifier may examine the number of cusps, a third weak classifier may examine arc length, and so on. In some embodiments, approximately eighty weak classifiers may be used.

As mentioned above, an AdaBoost classifier is a set of weighted weak classifiers. A unique AdaBoost classifier may be created for each unique pair of candidate symbols by repeatedly applying the AdaBoost classifier to a training set of target symbols and updating the weights used for each weak classifier based on the results of each repetition. In some embodiments, the training set used to create the AdaBoost classifiers may be a set of symbols handwritten by the user who plans to use the mathematical sketching program. Such a method may provide more consistent results of handwriting recognition than non-user-specific handwriting recognizers.

A final classifier then determines which candidate symbol most closely matches the target symbol by tallying the results of the operation of each unique AdaBoost classifier on each unique pair. The final classifier selects the symbol that is selected most often during the operation of each AdaBoost classifiers on its respective unique pair of candidate symbols.

After the mathematical symbols are recognized in symbol recognition module 71, mathematical expression recognition module 70 may use an expression parser module 77 to two-dimensionally parse the symbols in terms of exponents, subscripts, fractions, and other constructs. For example, the mathematical symbols may be parsed according to methods described in Blostein, D., and Grbavec, A. 2001, Recognition of Mathematical Notation., In Handbook of Character Recognition and Document Image Analysis, World Scientific, H. Bunke and P. Wang, Eds., 557-582, which is hereby incorporated by reference herein in its entirety. Mathematical expression recognition module 70 may take the symbols and convert them to form semantically-correct expressions. Because the symbols may be written in a two-dimensional notation; that is, written with subscripts, superscripts and fractions at different vertical positions relative to a base term, the symbols and their bounding box information may be used to parse the collection of symbols into equivalent one-dimensional expressions (i.e., no subscripts or superscripts positioning) which may then be used as input to computational engine module 56. The parsing algorithm may first sort the symbols horizontally and then may handle symbols' verticality (e.g., fraction constructs, subscripts, superscripts, etc.). The algorithm may use a context-free grammar along with the bounding box information to determine relative locations between symbols. Simple location tests may be performed to determine relationships between symbols. For example, the parser may inspect an “x” followed by a “2”, and if the “2” is higher relative to the “x “(i.e., above the center of the x's bounding box) the expression is recognized as “x²”. If the “2” is lower than the center of the bounding box of the “x”, then the “2” is parsed as a subscript and the expression is recognized as “x₂”. Similar rules may be used for fractions, square roots, and other constructs. These rules may be applied in conjunction with the grammar to parse the expressions.

After an expression is parsed, the expression may be sent to a contextual analyzer module 79 which reduces errors by looking for parts of the expression which do not appear sensible. Certain symbols are often hard to distinguish from one another if they are handwritten, such as “0” and “o”, or “s” and “5”. Therefore, certain characters may be replaced in response to prescribed rules. For example, if an initial recognition algorithm outputs “c0s(x)”, the “0” may be replaced with an “o” to form “cos(x)”. In another example, if an initial recognition algorithm outputs “5 in(t)”, the “5” may be replaced with an “s” to form “sin(t)”.

Regarding mathematical expression recognition, each of the following documents is hereby incorporated by reference herein in its entirety: Connell, S. D., and Jain, A. K. 2000. Template-based on-line character recognition. Pattern Recognition 34, 1, 1-14; and Smithies, S., Novins, K., and Arvo, J. 1999. A handwriting-based equation editor. In Proceedings of Graphics Interface '99, 84-91.

An association module 72 may be included in sketch parser module 54 for creating associations between mathematical expressions and drawing elements. In some embodiments, some or all of the associations are provided to module 72 through explicit gesturing or programming by the user. In other embodiments, module 72 implicitly associates one or more mathematical expressions with a drawing element based on the drawings variable label.

For implicit associations, an expression may be associated with a drawing element if the expression takes part in the computation of any variable that falls in the “label family” of the drawing element's variable label. A label family is defined by its name, which may be a root string. Members of the label family may be variables that include the root string and a component subscript (e.g., x for its x-axis component) or a function specification. For example, if the user labels a drawing element Φ₀, the inferencing system may determine the label family to be Φ and finds all mathematical expressions having members of the Φ label family on the left-hand side of the equal sign (for example, Φ, Φ₀, Φ(t), Φₓ(t) and so on). Module 72 then may find all of the variable names appearing on the right-hand side of the equal sign, determine their label families, and proceed to search for expressions that fall in these label families. After all of the related mathematical expressions have been found, they are sorted to represent a logical flow of operations that can be executed by computational engine module 56, and the implicit association is made.

For example, in the embodiment illustrated in FIG. 2, after the variable “y” is linked to mass 10, the system may search for mathematical expressions that contain “y” on the left hand side of the equation, e.g., equation 7. The system may then look at each of the variables and constants present on the right hand side of equation 7, e.g., w, t, b, A, and m, and search for mathematical expressions for each of these variables or constants. This method may continue until no further variables or constants remain to be searched. It should be appreciated that other methods or modules may be used to implicitly associate one or more mathematical expressions with particular drawing elements.

In some embodiments, module 72 may be configured (e.g., in conjunction with other components of system 50) to handle interrelated equations such as x(t)=t²y(t) and y(t)=x(t)-t by detecting the dependencies, solving the dependencies with computational engine module 56, presenting the solutions to the user, and providing the user with the ability to interactively select the appropriate solutions to use in the sketches.

Sketch parser module 54 may be capable of defining a coordinate system based on the positions of the drawing elements. The embodiment illustrated in FIG. 4a includes a drawing dimensions definition module 74 to infer coordinate systems. In other embodiments, a user may explicitly create a Cartesian coordinate system within a sketched diagram.

Module 74 may be configured to implement a first method of inferring a coordinate system if two different drawing elements are associated with mathematical expressions so that each drawing element has a different value for one of its coordinates (e.g., x or y). The distance along the coordinate shared between the two drawing elements establishes a dimension for the coordinate system, and the location of the drawing elements may be used to infer the location of the coordinate system origin.

Module 74 may be configured to implement a second method of inferring a coordinate system if only one drawing element is associated with mathematical expressions. The inference may be made if another drawing element is associated with a numerical label. In some embodiments of the system, whenever a numerical label is applied to a drawing element, the system analyzes the drawing element to determine if it is a horizontal or vertical line. If the drawing element is a horizontal or vertical line, a corresponding x or y-axis dimension is established. If the drawing element is not a horizontal or vertical line, the label may be applied to a best-fit line of the drawing element, and the dimension of both coordinate axes may be established.

In cases where insufficient information is specified to define a coordinate system implicitly, a default coordinate system may be used. Of course, in some embodiments, as will be evident to those of skill in the art, other suitable methods of defining coordinate systems may be used.

In the illustrated embodiment, a drawing rectification module 76 may be used to adjust the correspondence between drawing elements and mathematical expressions. For example, a user might draw a diagram containing an angle, and then write a mathematical expression that specifies the same angle numerically. The drawn angle is unlikely to match the mathematical expression exactly. Drawing rectification module 76 may be used to adjust the drawing to the mathematical expression or vice versa.

In acyclic relationships, rectification is fairly straightforward. In one embodiment, a diagram component such as a drawn angle is computed. Next, the system determines if a mathematical expression corresponding to the diagram component exists. If one does exist, the diagram component may be adjusted such that it matches the mathematical expression. If no mathematical expression exists, the diagram component may be used to compute a numerical value and this value can be used to create a numerical specification for the diagram component. For cyclic relationships, a more sophisticated approach such as constraint satisfaction algorithms may be used.

As mentioned above, not all of the modules described in association with FIGS. 4a and 4b are required for implementation of various embodiments, nor must the functions and structures of the various modules be associated only with one module.

System 1 or System 50, and components thereof such as input/output device 2, computational and animation engine 15, database 17, drawing element data structures 19, mathematical expression data structures 21, linking data structures 23, input/output device 51, user input interface module 52, sketch parser module 54, computational engine module 56, animation engine module 58, and output display interface module 60, may be implemented using software (e.g., C, C#, C++, Java, or a combination thereof), hardware (e.g., one or more application-specific integrated circuits), firmware (e.g., electrically-programmed memory) or any combination thereof. One or more of the components of systems 1, 50 may reside on a single system (e.g., a tablet computer system), or one or more components may reside on separate, discrete systems. Further, each component may be distributed across multiple systems, and one or more of the systems may be interconnected.

Further, on each of the one or more systems that include one or more components of systems 1, 50, each of the components may reside in one or more locations on the system. For example, different portions of the components systems 1, 50 may reside in different areas of memory (e.g., RAM, ROM, disk, etc.) on the system. Each of such one or more systems may include, among other components, a plurality of known components such as one or more processors, a memory system, a disk storage system, one or more network interfaces, and one or more busses or other internal communication links interconnecting the various components.

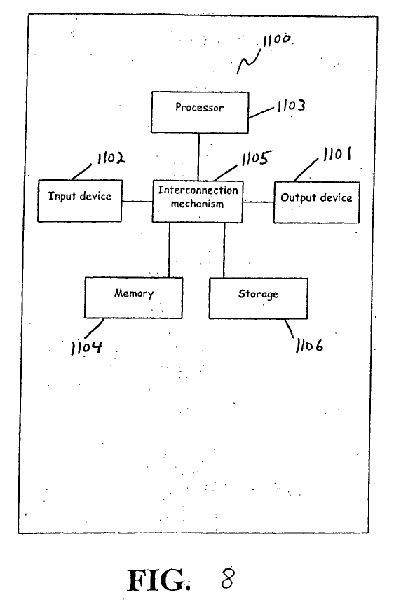

Systems 1, 50 may be implemented on a computer system described below in relation to FIG. 8.

Systems 1, 50 are merely illustrative embodiments of mathematical sketching systems. Such illustrative embodiments are not intended to limit the scope of the invention, as any of numerous other implementations of mathematical sketching systems are possible and are intended to fall within the scope of the invention.

Method of Using Mathematical Sketching System

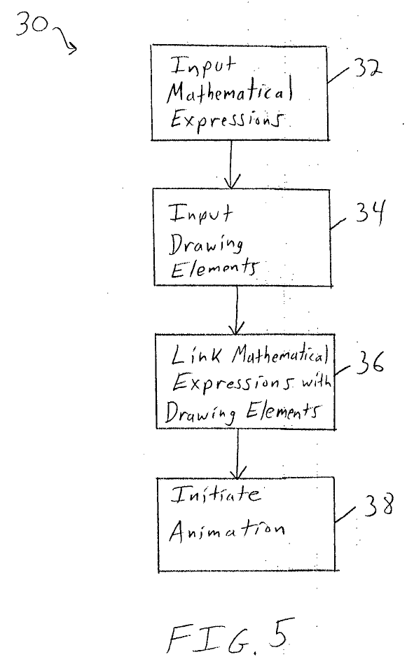

An example of a method 30 of initiating animation of a hand-drawn drawing based on a handwritten mathematical expression by using a mathematical sketching system is illustrated in FIG. 5. In act 32, a user may input, into a mathematical sketching system, mathematical expressions, using techniques described by way of example below including any of: equations, logic expressions, assignments of values to constants, definitions of initial conditions and domain ranges, other types of mathematical expressions, and any combination thereof. In certain embodiments, using gesture marks, a user writes an entire mathematical expression, such as an equation, on an input device and then lassos the equation and taps inside the lasso to instruct the system to attempt to recognize the expression. As described above in the Definitions Section, a lasso is an ink stroke or mark, or a set of ink strokes or marks, that partially or completely encloses one or more ink marks. In some embodiments, instead of separately instructing the system to attempt to recognize each expression as it is written, the user may lasso a group of expressions, or even all the expressions on the display, simultaneously to instruct the system to attempt to recognize all of the lassoed expression. To handle such a instruction, the system may include an additional processing step of separating expressions based on their positions and/or contents.

When the system recognizes an expression, it may re-display the expression according to its understanding. The re-display of the expression may use previously entered samples of the user's own handwriting, as described above with reference to mathematical expression recognition module 70. In other embodiments, the system may learn the user's handwriting for various numbers, letters, operators, etc. during regular use of the system. Of course, those of skill in art will recognize that the re-display of expressions may be in a typical computer text font, another person's handwriting, or a generic handwriting font. The re-display of the expression allows the user to confirm that the handwritten expression was properly recognized. If errors are noticed by the user, corrections can be made and the expression is once again lassoed and tapped to instruct the system to attempt to recognize the expression.

In act 34, the user may input one or more drawing elements. In some embodiments, a stylus, a finger, a light pen, a track ball, a computer mouse, or other gestural input implement may be used to input drawings to the system. In some embodiments, drawings from handwritten pages or textbooks may be electronically scanned using a typical computer scanner. In still other embodiments, a digital ink-collecting pen may be used; that is, a writing implement that writes on a regular piece of paper, but is able to record and/or transmit the strokes electronically. In still further embodiments, a gestural drawing element may be input by copying a gestural drawing element from an electronic file.

In some embodiments, a primitives-based drawing system may be used in which certain shapes or drawing elements are recognized to be representative of specific shapes or entities. In some embodiments, ink strokes are not recognized as primitives and they may be simply stored as pixel-based data.

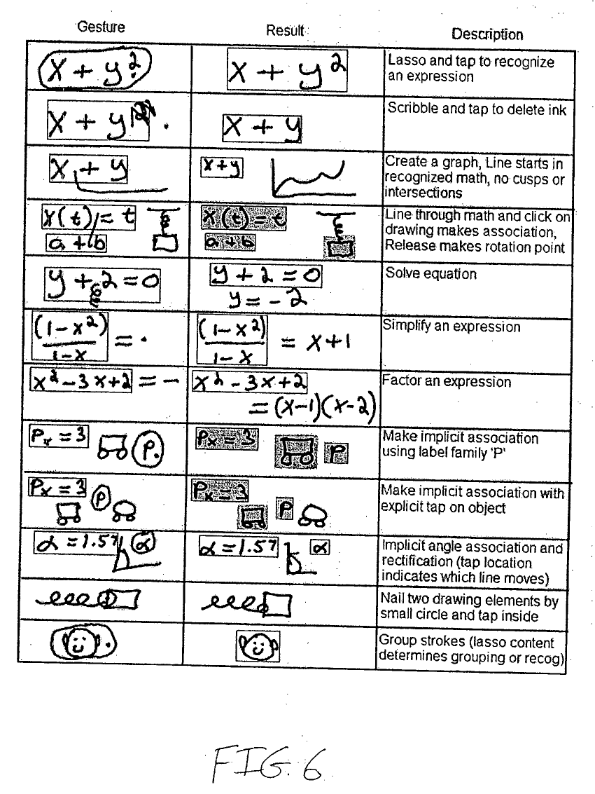

As part of act 34, a drawing element may be “nailed” in order to fix a position of (i.e., “pin”) a drawing element in relation to the background or to pin a point on a drawing element in relation to a position of another drawing element, according to various embodiments. For a first drawing element nailed to a second drawing element, if the first drawing element is moved during control of the display, the second drawing element moves rigidly to stay attached at the nail if the second drawing element has only one nail. If the second drawing is additionally nailed to other drawing elements, the second drawing element deforms so that its multiple nails maintain their points of attachment. A gesture command that may be used to create a nail is described below with reference to FIG. 6.

Because many drawings involve creating one diagram object from a set of drawing elements, a grouping operation may be specified by drawing a lasso around drawing elements. In some embodiments, the system may be configured to automatically determine whether the lassoed marks are drawing elements or text. In other embodiments, a slight distinction in the gesturing operation signifies whether a grouping operation is being requested or the system is being requested to recognize a mathematical expression. For example, the gesture command to recognize a mathematical expression may include a lasso and a double tap. Whereas the gesture command to group marks or drawing elements into a drawing object may include a lasso and a single tap. By allowing distinguishing gesture commands, in some embodiments the system does not require separate modes for inputting mathematical expressions versus drawing elements. In some embodiments, however, the system may allow switching between modes, such as by tapping a virtual button to indicate a change from “drawing element” mode to “mathematical expression” mode for example.

In act 36, the user may link one or more mathematical expressions with one or more drawing elements. The mathematical sketching system then may associate one or more mathematical expressions with one or more drawing elements, as described above with reference to association module 72. In this manner, the display of a drawing element, for example during an animation, may be controlled by an associated mathematical expression or expressions. In some embodiments, links are made between scalar mathematical expressions and angular arcs, or one of the three special values of a drawing element—its x, y or rotation coordinate. For example, a mathematical equation may define a drawing element's x-coordinate position to be:
x(t)=4t.

As t progresses from, for example, zero to twelve during an animation, the drawing element moves from x-coordinate position zero to x-coordinate position forty-eight. Once an association is made, changes in mathematical expressions may be reflected as changes in the diagram and vice versa.

Associations between mathematical expressions and drawing elements can be made either explicitly and/or implicitly, according to one embodiment of the invention. To create an implicit association, the user may draw a variable name or constant value near an intended drawing element and then use the mathematical recognition gesture command (e.g., lasso-and-tap) to recognize the label. The system may use the recognized label and associated drawing element to infer associations with mathematical expressions input by the user. In one embodiment, if tap portion of the recognition gesture is made within an area defined by the lasso, the label is linked to the nearest drawing element. Alternatively, if the label is rotational, the location of the tap may be used to specify both the drawing element to be linked to the label and the center of rotation of the drawing element if the label defines a rotational relationship. For example, when labeling an angle arc, the location of the tap on the arc may determine the “active line,” that is, the line attached to the arc that will move when the angle changes. One embodiment of an association module is described above with reference to FIG. 4a.

Associations also may be created explicitly without using variable name labels. For example, the user may initiate an explicit association by drawing a line through a set of related mathematical expressions and then tapping on a drawing element to which the mathematical expressions are to be associated. Once the line is drawn, drawing elements may change color as the stylus hovers over them to indicate the potential for an association, according to some implementations of the invention.

In embodiments in which the ability to make both implicit and explicit associations is provided, various suitable options exist for visually indicating which drawing elements, labels and expressions have been associated with one another. For example, the bounding boxes of associated components may be filled with the same semi-transparent color.

Returning to method 30, in act 38, the user may initiate animation. This initiation may be achieved by a gesture command or by tapping a button or a virtual button, or any other suitable technique. In some embodiments, the user may control animation by slowing down or speeding up the animation, pausing the animation, stopping the animation, selecting a value of domain variable 20 at which to view the animation display, playing the animation in reverse, or by controlling many other aspects of the animation, as will be evident to those of skill in the art. In some embodiments, it may be provided that once an animation is initiated, the user does not control the animation.

Method 30 may include additional acts. Further, the order of the acts performed as part of method 30 is not limited to the order illustrated in FIG. 5 as the acts may be performed in other orders, and one or more of the acts of method 30 may be performed in series or in parallel to one or more of the other acts, or parts thereof. For example, acts 32 and 34 may be performed in parallel as the inputting of mathematical expressions is intermixed with the inputting of drawing elements. As another example, the order of act 32 and act 34 may be reversed.

Method 30 is merely an illustrative embodiment of initiating animation. Such an illustrative embodiment is not intended to limit the scope of the invention, as any of numerous other implementations of initiating animation are possible and are intended to fall within the scope of the invention.

Method 30, acts thereof and various embodiments and variations of these methods and acts, individually or in combination, may be defined by computer-readable signals tangibly embodied on a computer-readable medium, for example, a non-volatile recording medium, an integrated circuit memory element, or a combination thereof. Such signals may define instructions, for example, as part of one or more programs, that, as a result of being executed by a computer, instruct the computer to perform one or more of the methods or acts described herein, and/or various embodiments, variations and combinations thereof. Such instructions may be written in any of a plurality of programming languages, for example, Java, Visual Basic, C, C#, or C++, Fortran, Pascal, Eiffel, Basic, COBOL, etc., or any of a variety of combinations thereof. The computer-readable medium on which such instructions are stored may reside on one or more of the components of systems 1, 50 described above, and may be distributed across one or more of such components.

The computer-readable medium may be transportable such that the instructions stored thereon can be loaded onto any computer system resource to implement the aspects of the present invention discussed herein. In addition, it should be appreciated that the instructions stored on the computer-readable medium, described above, are not limited to instructions embodied as part of an application program running on a host computer. Rather, the instructions may be embodied as any type of computer code (e.g., software or microcode) that can be employed to program a processor to implement the above-discussed aspects of the present invention.

It should be appreciated that any single component or collection of multiple components of a computer system, for example, the computer system described below in relation to FIG. 8, that perform the functions described above with respect to describe or reference the method can be generically considered as one or more controllers that control the above-discussed functions. The one or more controllers can be implemented in numerous ways, such as with dedicated hardware, or using a processor that is programmed using microcode or software to perform the functions recited above.

Examples of gesture commands that may be used for inputting mathematical expressions, drawing elements, and/or commands according to one embodiment or are shown in the first column of FIG. 6. The second column illustrates examples of results displayed by the system after recognizing the gesture commands. The third column provides a brief description of the gesture's instruction. The gesture commands shown in FIG. 6 are merely examples, and any suitable gesture commands and/or interaction scheme with the apparatus may be used.

One example of a gesture command is a sequence of two symbols which commands the system to simplify an expression. The user may write an equals sign (”=”) and follow that with a tap to instruct the system to simplify an instruction. If, instead of following the equals sign with a tap, the user follows the equals sign with a horizontal stroke, the system is instructed to factor an expression. Another example of a gesture command is the “nail” command. With this command, a small circle is drawn around the intersection of two drawing elements, and a tap is made inside the small circle. Other examples of gesture commands are provided in FIG. 6, and it should be appreciated that these are merely examples of gesture commands that may be used.

Two-Dimensional Projectile Motion Example

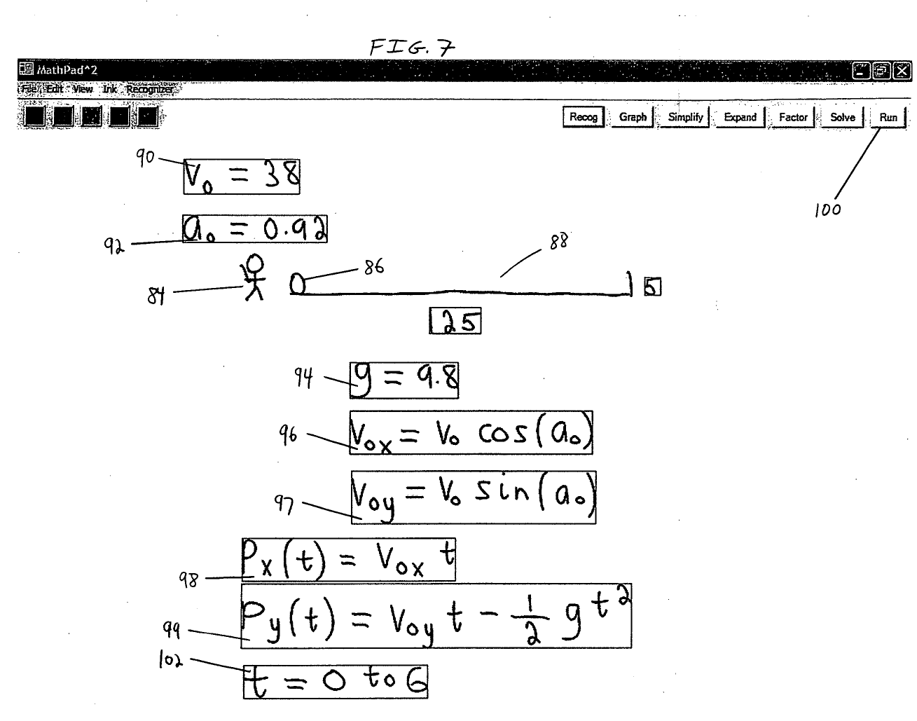

An example of using a mathematical sketching system will now be presented. A user interested in determining whether a baseball player can hit a ball 86 over a fence given an initial velocity and angle could use one embodiment of a mathematical sketching system in the following manner. The user draws a simple playing field 88 with dimensions as shown in FIG. 7. Initial values and known quantities are input by writing mathematical expressions 90, 92, 94. From the user's knowledge of projectile motion, mathematical expressions 96, 97, 98 and 99 are written. A range for domain variable 102 may be specified. Mathematical expressions 96, 97, 98 and 99 then may be associated with ball 86, for example, by the user linking the variable “P” with ball 86 and the system searching for and associating any relevant mathematical expressions in the “P” label family, as described above with reference to FIG. 3. Alternatively, the user may associate mathematical expressions 96, 97, 98 and 99 with ball 86 by drawing a line through the expressions and tapping on ball 86. These association methods are only examples, and any suitable method may be used. The user may then initiate an animation by tapping on run button 100.

The animation shows ball 86 moving in a parabola from left to right across the display until t achieves a value of 6 and the animation ends. The user may want to investigate the difference in distance traveled by the ball if the initial velocity V₀ is increased. The user changes the initial value of V₀ by scratching out the value of 38 and replacing it with a new value. With the new value, the ball may travel further, but not return to the ground because it remains aloft for more than t=6. This result may lead the user to the question of when the ball will hit the ground with the new parameters. To answer this question, equation 99 may be set equal to zero and solved, for example, by using the squiggle gesture shown in FIG. 6. The value of t returned for the solution of this equation may then be entered into domain field 102. When the animation is re-run, ball 86 returns to the ground and the distance of travel along the x-coordinate can be seen.

If errors were present in the initial mathematical formulation, the animation may help the user to recognize the error. For example, if expression 99 had a plus (+) sign instead of a minus (−) sign, the animation would show ball 86 traveling upwards at an increasing speed. The animation would, therefore, indicate to the user that something was perhaps wrong with the calculation of the y-coordinate location.

Various embodiments according to the invention may be implemented on one or more computer systems. These computer systems may be, for example, tablet computers such as a Hewlett-Packard Compaq Tablet PC tc1100. These computer systems also may be, for example, general-purpose computers such as those based on Intel PENTIUM-type processor, Motorola PowerPC, Sun UltraSPARC, Hewlett-Packard PA-RISC processors, or any other type of processor. It should be appreciated that one or more of any type of computer system may be used to practice the invention according to various embodiments of the invention. Further, a system may be located on a single computer or may be distributed among a plurality of computers attached by a communications network.

A general-purpose computer system according to one embodiment of the invention is configured to execute embodiments of the invention disclosed herein. It should be appreciated that the system may perform other functions, for example, executing other applications, or executing embodiments of the invention as part of another application.

For example, various aspects of the invention may be implemented as specialized software executing in a general-purpose computer system 1100 such as that shown in FIG. 8. The computer system 1100 may include a processor 1103 connected to one or more memory devices 1104, such as a disk drive, memory, or other device for storing data. Memory 1104 is typically used for storing programs and data during operation of the computer system 1100. Components of computer system 1100 may be coupled by an interconnection mechanism 1105, which may include one or more busses (e.g., between components that are integrated within a same machine) and/or a network (e.g., between components that reside on separate discrete machines). The interconnection mechanism 1105 enables communications (e.g., data, instructions) to be exchanged between system components of system 1100. Computer system 1100 also includes one or more input devices 1102, for example, a keyboard, mouse, trackball, digitizing surface microphone, touch screen, and one or more output devices 1101, for example, a printing device, display screen, or a speaker. In addition, computer system 1100 may contain one or more interfaces (not shown) that connect computer system 1100 to a communication network (in addition or as an alternative to the interconnection mechanism 1105). Computer System 1100 may be a tablet computer and may include modules such as those shown in FIG. 3.

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

Although computer system 1100 is shown by way of example as one type of computer system upon which various aspects of the invention may be practiced, it should be appreciated that aspects of the invention are not limited to being implemented on the computer system as shown in FIG. 8. Various aspects of the invention may be practiced on one or more computers having a different architecture or components that that shown in FIG. 8.

Computer system 1100 may be a general-purpose computer system that is programmable using a high-level computer programming language. Computer system 1100 may be also implemented using specially programmed, special purpose hardware. In computer system 1100, processor 1103 is typically a commercially available processor such as the well-known Pentium class processor available from the Intel Corporation. Many other processors are available. Such a processor usually executes an operating system which may be, for example, the Windows 95, Windows 98, Windows NT, Windows 2000 (Windows ME) or Windows XP operating systems available from the Microsoft Corporation, MAC OS System X available from Apple Computer, the Solaris Operating System available from Sun Microsystems, Linux, or UNIX available from various sources. Many other operating systems may be used.

The processor and operating system together define a computer platform for which application programs in high-level programming languages are written. It should be understood that the invention is not limited to a particular computer system platform, processor, operating system, or network. Also, it should be apparent to those skilled in the art that the present invention is not limited to a specific programming language or computer system. Further, it should be appreciated that other appropriate programming languages and other appropriate computer systems could also be used.

One or more portions of the computer system may be distributed across one or more computer systems (not shown) coupled to a communications network. These computer systems also may be general-purpose computer systems. For example, various aspects of the invention may be distributed among one or more computer systems configured to provide a service (e.g., text recognition) to one or e, various aspects of the invention may be performed on a Client-Data Server Module system that includes components distributed among one or more systems that perform various functions according to various embodiments of the invention. These components may be executable, intermediate (e.g., IL) or interpreted (e.g., Java) code which communicate over a communication network (e.g., the Internet) using a communication protocol (e.g., TCP/IP).

It should be appreciated that the invention is not limited to executing on any particular system or group of systems. Also, it should be appreciated that the invention is not limited to any particular distributed architecture, network, or communication protocol.

Various embodiments of the present invention may be programmed using an object-oriented programming language, such as SmallTalk, Java, C++, Ada, or C# (C-Sharp). Other object-oriented programming languages also may be used. Alternatively, functional, scripting, and/or logical programming languages may be used. Various aspects of the invention may be implemented in a non-programmed environment (e.g., documents created in HTML, XML or other format that, when viewed in a window of a browser program, render aspects of a graphical-user interface (GUI) or perform other functions). Various aspects of the invention may be implemented as programmed or non-programmed elements, or any combination thereof.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one act, the order of the acts of the method is not necessarily limited to the order in which the acts of the method are recited.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A computer system comprising:
a user interface module to receive a gestural drawing element and a gestural mathematical expression from a user; and
an animation module to control a display of the gestural drawing element based on the gestural mathematical expression.

2. A computer system as in claim 1, wherein the animation module animates the display of the drawing element.

3. A computer system as in claim 1, wherein the user interface receives input from the user that indicates an association of the gestural mathematical expression to the gestural drawing element.

4. A computer system as in claim 3, further comprising an association module that associates the mathematical expression to the drawing element.

5. A computer system as in claim 1, further comprising an association inferencing module which associates the gestural mathematical expression to the gestural drawing element.

6. A computer system as in claim 1, wherein the user interface module is configured to receive a plurality of gestural drawing elements.

7. A computer system as in claim 1, wherein the user interface module is configured to receive a plurality of gestural mathematical expressions, and the association module associates the plurality of mathematical expression to the drawing element.

8. A computer system as in claim 1, wherein the user interface module is configured to receive the gestural drawing element and the gestural mathematical expression from a digitizing surface that is used with a stylus.

9. A computer system comprising:
a user interface module to receive a drawing element and to receive a gestural mathematical expression from a user; and
an association module to associate the gestural mathematical expression to the drawing element.

10. A computer system as in claim 9, wherein the drawing element is a gestural drawing element.

11. A computer system as in claim 10, further comprising an expression recognition module to convert the gestural mathematical expression to a format that facilitates manipulation of the mathematical expression by the computer system.

12. A computer system as in claim 9, wherein the association module receives input from the user that indicates an association.

13. A computer system as in claim 9, wherein the user interface module receives handwritten mathematical expressions from the user.

14. A computer system as in claim 9, wherein the mathematical expression is a mathematical equation.

15. A computer system as in claim 9, wherein the mathematical expression is a logic expression.

16. A computer system as in claim 9, wherein the mathematical expression is a conditional operator.

17. A computer system as in claim 9, wherein the mathematical expression is an iteration operator.

18. A computer system as in claim 9, wherein the user interface communicates with a digitizing surface.

19. A computer system as in claim 18, further comprising a stylus to write the mathematical expression on the digitizing surface.

20. A computer system as in claim 9, wherein the user interface receives a plurality of gestural mathematical expressions from the user, and the association module associates the plurality of gestural mathematical expressions to the drawing element.

21. A computer-readable medium having computer-readable signals stored thereon that define instructions that, as a result of being executed by a computer, instruct the computer to perform a method comprising acts of:
receiving a gestural drawing element from a user;
receiving a gestural mathematical expression from the user; and
animating a display of the gestural drawing element based on the gestural mathematical expression.

22. A computer-readable medium as in claim 21, wherein the act of receiving a gestural mathematical expression comprises receiving a mathematical expression that was written with a stylus by the user.

23. A computer-readable medium having computer-readable signals stored thereon that define instructions that, as a result of being executed by a computer, instruct the computer to perform a method comprising acts of:
receiving a drawing element and a gestural mathematical expression from a user; and
associating the gestural mathematical expression to the drawing element.

24. A computer-readable medium as in claim 23, wherein the act of receiving a drawing element comprises receiving a gestural drawing element that was drawn with a stylus by the user.

25. A computer-implemented method of animating a display, comprising:
receiving at least one gestural drawing element and at least one gestural mathematical expression;
associating the at least one gestural mathematical expression to the at least one gestural drawing element; and
responding to instructions to animate a display of the at least one gestural drawing element based on the gestural mathematical expression.

26. A computer-implemented method as in claim 25, wherein receiving the gestural mathematical expression comprises receiving a gestural mathematical expression written with a stylus on a digitizing surface.

27. A computer-implemented method as in claim 25, wherein the at least one gestural mathematical expression comprises a plurality of gestural mathematical expressions.

28. A computer-implemented method as in claim 27, wherein the at least one gestural drawing element comprises a plurality of gestural drawing elements.

29. A computer-implemented method of animating a display of one or more drawing elements based on one or more handwritten mathematical equations, comprising:
drawing one or more drawing elements on a digitized surface;
handwriting one or more mathematical equations on the digitized surface;
associating at least one of the handwritten mathematical equations to at least one of the drawing elements using a gesture command; and
initiating animation of the at least one drawing element by tapping a virtual button on the digitized surface.

30. A computer-implemented method as in claim 29, wherein a stylus is used to draw and handwrite on the digitized surface.

31. A computer-implemented method as in claim 29, wherein the mathematical equations comprise a plurality of mathematical equations representing a mass-spring system.

32. A computer-implemented method comprising:
receiving a drawing element and a gestural mathematical expression from a user; and
associating the gestural mathematical expression to the drawing element.

33. A computer-implemented method of animating a display of one or more drawing elements based on at least one gestural mathematical equation, comprising:
inputting one or more drawing elements;
inputting one or more gestural mathematical equations;
associating at least one of the gestural mathematical equations to at least one of the drawing elements;
animating the at least one drawing element;
comparing the animation of the at least one drawing element to an expected animation; and
revising at least one of the gestural mathematical equations based on the comparison.
